(19) United States
(12) Patent Application Publication
(10) Pub. No.: US 2024/0265113 A1
(43) Pub. Date: Aug. 8, 2024

(54) Systems and Methods to Determine Attack Paths to Application Assets

(71) Applicant: Cisco Technology, Inc., San Jose, CA (US)

(72) Inventors: Jeffrey M. Napper, Delft (NL); Hendrikus G. P. Bosch, Aalsmeer (NL); Jean Diaconu, Gaillard (FR); Marcelo Yannuzzi, Nuvilly (CH); Alessandro Duminuco, Milano (IT)

(21) Appl. No.: 18/330,255

(22) Filed: Jun. 6, 2023

Related U.S. Application Data
(60) Provisional application No. 63/483,144, filed on Feb. 3, 2023.

(51) Int. Cl. G06F 21/57; G06F 21/55

(52) U.S. Cl. CPC G06F 21/577; G06F 21/552; G06F 2221/033

(57) ABSTRACT

A system and a method to determine attack paths to application assets may include storing in a memory asset inventory indicating multiple application assets, multiple attack vector parameters configured to indicate vulnerabilities of one or more of the application assets, and asset mapping information configured to associate each of the application assets to one or more of the application layers. A processor may determine multiple vulnerable assets in the application assets based at least in part upon the attack vector parameters. Further, the processor may determine feasibility parameters that indicate a likelihood of the attack path to occur in the system, generate a visual interface showing the vulnerable assets, determine an attack path connecting the vulnerable assets based at least in part upon the asset mapping information, and map the attack path to the application layers in the visual interface based at least in part upon the feasibility parameters.

### TECHNICAL FIELD

The present disclosure relates generally to a field of application asset protection, and more particularly, to a system and a method to determine attack paths to application assets.

### BACKGROUND

Application assets (e.g., application data and application resources) are at risk of being exploited by bad actors. In some cases, data used by an application may be corrupted or stolen by these bad actors that destabilize security safeguards in one or more layers of the application. The bad actors may corrupt the data by modifying or copying the data in the application.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an example system, according to some embodiments of the present disclosure;

FIG. 2 illustrates an example operational flow of the system of FIG. 1, according to some embodiments of the present disclosure;

FIG. 3 illustrates an example attack path analysis for the system of FIG. 1, according to some embodiments of the present disclosure; and

FIG. 4 illustrates an example process for performing the operational flow of FIG. 2, according to some embodiments of the present disclosure.

### DESCRIPTION OF EXAMPLE EMBODIMENTS

### Overview

In one or more embodiments, a system and a method described herein determine attack paths to applications assets across multiple application layers of an application while providing a comprehensive understanding of vulnerabilities across the application layers. The system and the method prevent application assets (e.g., application data and application resources) from being at risk of being exploited by bad actors. In some embodiments, the system and the method may prevent data used by an application from being corrupted or stolen by these bad actors to destabilize security safeguards in one or more layers of the application. In other embodiments, the system and the method may prevent bad actors to modify or copy assets in the application. In this regard, the impact of potential attacks by these actors is drastically reduced in the application because the system and the method provide understanding and visualization of vulnerabilities across the application layers in attack paths.

In one or more embodiments, the system and the method comprise collecting different signals from multiple sources and using the signals as inputs to one or more processors implementing an inference engine. The system and the method may comprise applying different techniques such as ontological knowledge and semantic relatedness to reason on any data gathered from the signals received. The system and the method may comprise generating a converged topological view, persisting the topological view, and using the topological view as a new input into the one or more processors as a feedback for the implementation of the inference engine. The system and the method may comprise applying another technique to identify, categorize, and map possible attack vectors both within and across different application layers and assets. Herein, attack vectors are possible entry points for attacks by bad actors in one or more of the application layers of the application. The application layers may comprise an application data layer, an application logic layer, an application infrastructure layer, and an application cloud infrastructure layer. The system and the method may persist attack vector parameters comprising the attack vectors and using the application service, data topology, and any relevant attack vectors as an input for an attack path analysis engine implemented by the one or more processors. The one or more processors may implement the attack path analysis engine to determine one or all feasible attack paths across the application layers based at least in part upon the attack vector parameters.

In other embodiments, the system and the method provide application asset protection in distributed and complex applications. For example, the system and the method provide end-to-end visibility of possible vulnerabilities in applications comprising operations interconnected to cloud platforms such as Microsoft® Azure™, Google Cloud™, and Amazon Web Services®. The system and the method may determine vulnerable assets across multiple application layers, visualize location of sensitive assets in the application layers, and determine whether the sensitive assets are secure. In yet other embodiments, the system and the method may monitor statuses and association of the sensitive assets to one or more respective application layers. In this regard, the system and method may enable observability and security posture implementation for specific asset categories across multiple application layers.

In one or more embodiments, the system and the method combine multiple signals from multiple application layers, and other sources, such as cyberattack standards and human experts, as inputs to provide a multi-layer attack path analysis. In some embodiments, the multi-layer attack path analysis comprises determining feasibility of attack paths targeting any vulnerable asset in the multiple application layers. Further, the multi-layer attack path analysis may include detecting a least resistant path that a bad actor may follow to get access to vulnerable assets (e.g., sensitive data) as well as prioritization and remediation techniques operating in a closed-loop control.

In some embodiments, the system and the method generate multiple attack paths that provide visualization of a set of impact goals bad actors may attempt to realize (e.g., data compromise, CPU theft, and the like). In this regard, the system and the method determine cyberattack tactics and techniques that the bad actors may implement to construct attack paths to realize the impact goals. The system and the method may dynamically generate these attack paths by combining and recombining tactics and techniques. In other embodiments, the system and the method generate an application visualization interface (e.g., a graph) with all asset dependencies and interrelationships, where each of the assets in the visualization interface may include exploitable vulnerabilities. Further, the system and the method may generate the attack by crafting a path through the visualization interface using lateral movement and privilege escalation across multiple layers of the application. Each attack path may be a representation of a starting point in which a bad actor may use an initial attack vector to get into one layer of the application and obtains additional access to realize an impact. At each vulnerable asset (e.g., node) the visualization interface may provide the impact that may be potentially realized by the bad actor.

In accordance with one or more embodiments, a system or an apparatus, such as a network component, includes a memory and a processor communicatively coupled to one another. The system may determine attack paths to application assets. The memory may store an asset inventory indicating multiple application assets, first attack vector parameters that indicate vulnerabilities of one or more of the application assets, and asset mapping information that associates each of the application assets to one or more of multiple application layers. The application layers may include an application data layer, an application logic layer, an application infrastructure layer, and an application cloud infrastructure layer. The processor may determine first vulnerable assets in the application assets based at least in part upon the first attack vector parameters, determine first feasibility parameters that indicate a first likelihood of the first attack path to occur in the system, generate a visual interface showing the vulnerable assets, and determine a first attack path connecting the first vulnerable assets based at least in part upon the asset mapping information. Further, the processor may map the first attack path to the application layers in the visual interface based at least in part upon the first feasibility parameters.

In some cases, the first feasibility parameters further indicate a first starting point of the first attack path.

In certain cases, the processor may further obtain second attack vector parameters, determine second vulnerable assets in the application assets based at least in part upon the second attack vector parameters, and generate the visual interface showing the first vulnerable assets and the second vulnerable assets. Further, the processor may determine a second attack path connecting the second vulnerable assets based at least in part upon the asset mapping information, determine second feasibility parameters that indicate a second likelihood of the second attack path to occur in the system, and map the second attack path to the application layers in the visual interface based at least in part upon the second feasibility parameters. The second feasibility parameters further indicate a second starting point of the second attack path.

In some cases, in conjunction with determining first vulnerable assets, the processor may further determine a first weighted cost to compromise the first vulnerable assets from the first attack path. Further, in conjunction with determining second vulnerable assets, the processor may further determine a second weighted cost to compromise the second vulnerable assets from the second attack path, determine whether the first weighted cost is greater than the second weighted cost, and prioritize remediation for the second attack path in response to determining that the first weighted cost is greater than the second weighted cost. The processor may prioritize remediation for the first attack path in response to determining that the second weighted cost is greater than the first weighted cost.

In yet other cases, in response to the second weighted cost being greater than the first weighted cost, the processor may generate first threat prioritization parameters that indicate first corresponding priorities for each vulnerable asset in the first vulnerable assets, generate first remediation parameters that indicate a first solution to remediate the first attack path in the system, and assign the first threat prioritization parameters and the first remediation parameters to the first attack path in the visual interface. In response to the first weighted cost being greater than the second weighted cost, the processor may generate second threat prioritization parameters that indicate second corresponding priorities for each vulnerable asset in the second vulnerable assets, generate second remediation parameters that indicate a second solution to remediate the second attack path in the system, and assign the second threat prioritization parameters and the second remediation parameters to the second attack path in the visual interface.

In one or more embodiments, the first attack vector parameters may comprise a comprehensive list of attack vectors. Further, the first attack vector parameters may comprise information indicating vulnerabilities and potential intrusions in the application layers.

In accordance with other embodiments, a method comprises determining attack paths to application assets. The method may comprise obtaining multiple parameters comprising asset inventory indicating multiple application assets, attack vector parameters that indicate vulnerabilities of one or more of the application assets, and asset mapping information that associate each of the application assets to one or more application layers. The application layers may include an application data layer, an application logic layer, an application infrastructure layer, and an application cloud infrastructure layer. Further, the method may comprise determining multiple vulnerable assets in the application assets based at least in part upon the attack vector parameters, determining first feasibility parameters that indicate a first likelihood of the first attack path to occur in the system, generating a visual interface showing the vulnerable assets, determining an attack path connecting the vulnerable assets based at least in part upon the asset mapping information, and mapping the attack path to the application layers in the visual interface based at least in part upon the first feasibility parameters.

In accordance with yet other embodiments, a non-transitory computer readable medium stores instructions that when executed by a processor cause the processor to determine attack paths to application assets. The instructions may further cause the processor to obtain multiple parameters comprising asset inventory indicating multiple application assets, attack vector parameters that indicate vulnerabilities of one or more of the application assets, and asset mapping information that associate each of the application assets to one or more application layers. The application layers may include an application data layer, an application logic layer, an application infrastructure layer, and an application cloud infrastructure layer. The instructions may cause the processor to determine multiple vulnerable assets in the application assets based at least in part upon the attack vector parameters, determine first feasibility parameters that indicate a first likelihood of the first attack path to occur in the system, generate a visual interface showing the vulnerable assets, determine a first attack path connecting the vulnerable assets based at least in part upon the asset mapping information, and map the first attack path to the application layers in the visual interface based at least in part upon the first feasibility parameters.

Technical advantages of certain embodiments of this disclosure may include one or more of the following. The system and the method described herein determine attack paths to application assets associated with one or more application layers in a multi-layer application. Specifically, the system and the method reduce and prevent exposure to attacks from bad actors by providing visibility to vulnerable assets across the multiple application layers. In particular, the system and the method reduce or eliminate potential attacks from bad actors by enabling remediation of potential attacks at multiple entry levels in the application layers. As a result, vulnerabilities of assets may be reduced or eliminated before bad actors have an opportunity to exploit vulnerable assets.

In addition, the system and method described herein are integrated into a practical application of increasing processing speed and reducing memory usage in the system. Specifically, the system and the method reduce or eliminate delays or data congestions caused by attacks involving application assets. Further, the system and the method are integrated into a practical application of reducing an overall amount of network traffic due to pausing of application transmissions and operations resulting from bad actor interruptions. This reduces the traffic on the network and helps alleviate network bottlenecks that could otherwise occur during operations requiring multiple-layer application asset operations such as those involving Artificial Intelligence (AI) and Machine Learning (ML) procedures.

These practical applications may lead to a technical advantage of improving response speed and accuracy to user devices. For example, a technical advantage of one embodiment may allow for improved reliability in real-time communications between a client device and a server in which the application comprises one or more assets. In another example, another technical advantage of one embodiment may identify critical threats detected by the attack path analysis, prioritize these threats, and provide detailed steps enabling remediation actions to mitigate, reduce, or eliminate the threats.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

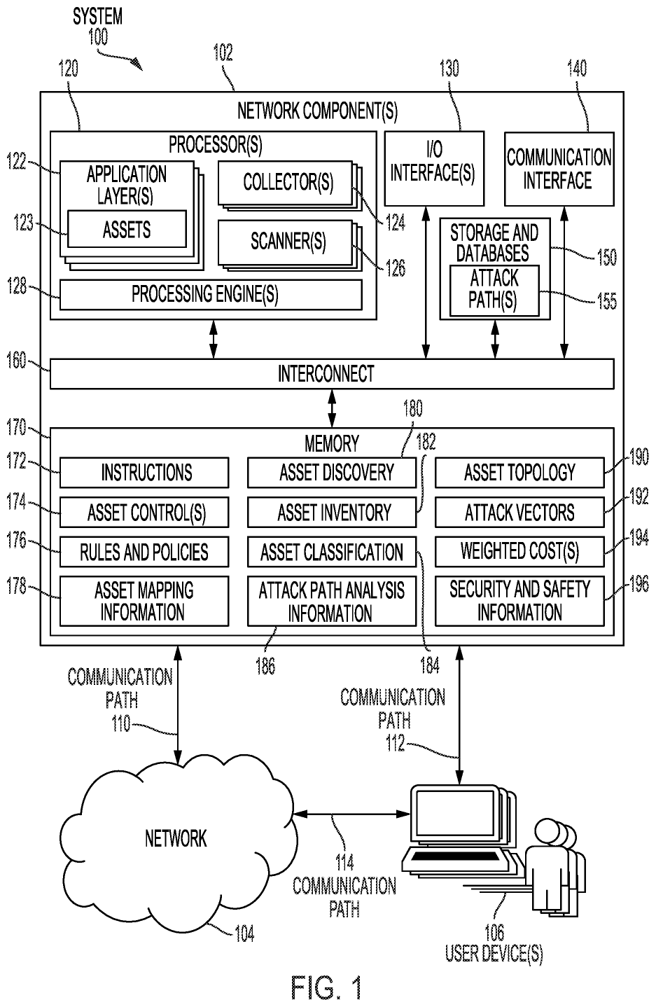

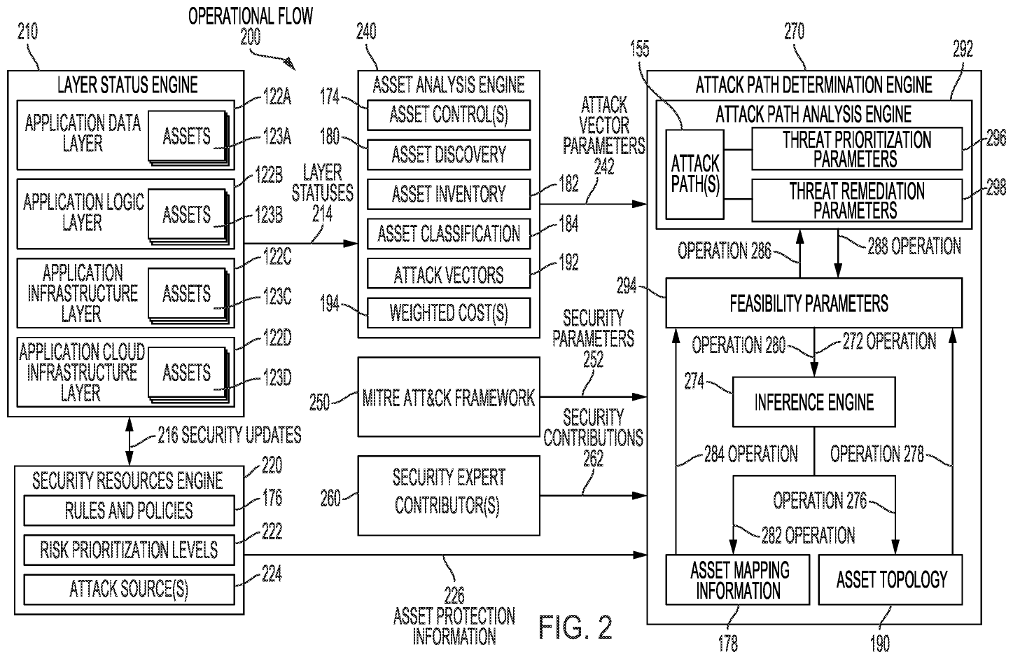

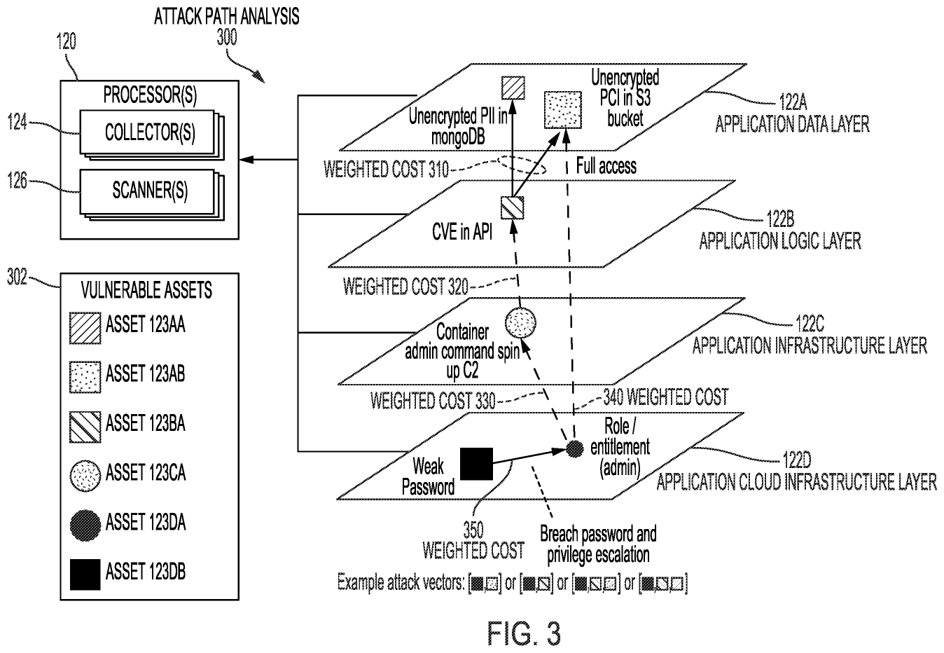

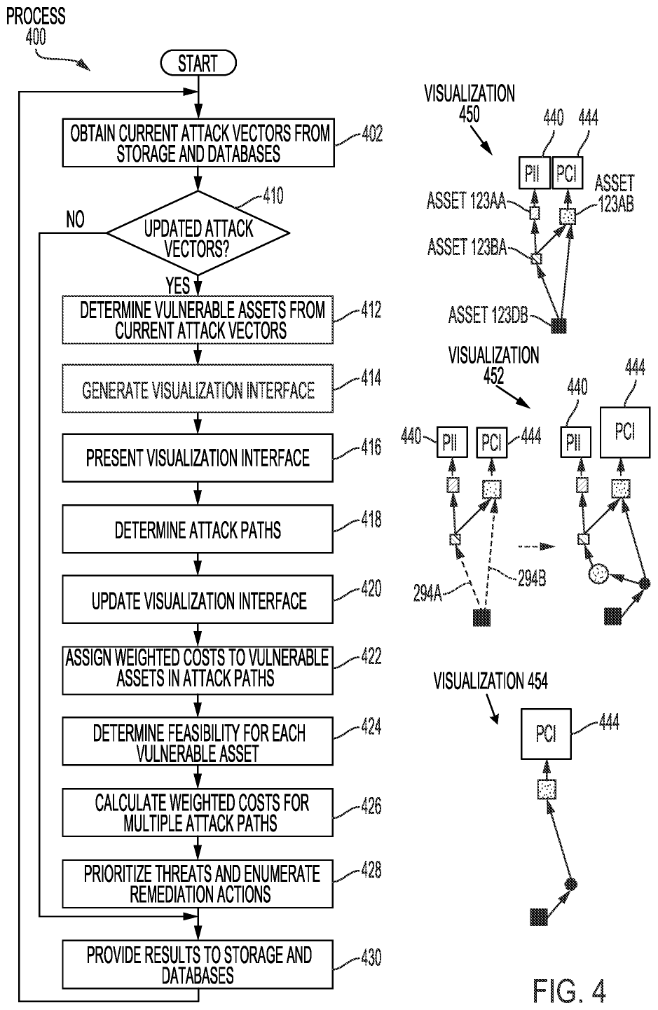

This disclosure describes systems and methods to determine attack paths to application assets associated with one or more application layers in a multi-layer application. In particular, this disclosure provides various systems and methods to reduce, prevent, or eliminate unsanctioned access to vulnerable assets of a multi-layered application structure by providing understanding, prioritization, and visualization of risks and attacks caused by bad actors in the application. FIG. 1 illustrates a system 100 in which one or more application layers 122 are analyzed to determine one or more attack paths 155 to application assets 123. FIG. 2 illustrates an operational flow 200 in which the system 100 of FIG. 1 is configured to implement an attack path analysis engine 292. FIG. 3 illustrates an attack path analysis 300 performed via the attack path analysis engine 292 of FIG. 2. FIG. 4 illustrates a process 400 to perform the operational flow 200 of FIG. 2.

FIG. 1 illustrates a system 100 configured to determine attack paths 155 to application assets 123, in accordance with one or more embodiments. The application assets 123 may be configured as part of an application that routes control commands and data signals among at least one network component 102, one or more client devices 106, and a network 104. In the system 100 of FIG. 1, the network component 102, the one or more client devices 106, and the network 104 are communicatively coupled to one another via multiple communication paths 110-114. For example, FIG. 1 shows that: the network component 102 and the network 104 are connected to one another via the communication path 110; the network component 102 and the one or more client devices 106 are connected to one another via the communication path 112; and the network 104 and the one or more client devices 106 are connected to one another via the communication path 114. The communication paths 110-114 may be wired or wireless connections among the at least one network component 102, the one or more client devices 106, or the network 104. In one or more embodiments, the network component 102 may be a hardware chassis configured to control data flow. The network component 102 may be configured to regulate data packet transmissions in the communication path 110 or the communication path 112. The communication paths 110-114 may include multiple bandwidth levels in which control signals and data signals may be transmitted using one or more communication protocols.

In one or more embodiments, the network 104 and the one or more client devices 106 may be a source or a destination for data packet transmissions monitored or controlled by one or more processors 120. In this regard, the communication interface 140 receives or transmits data packet transmissions exchanged with the network 104 via the communication path 110 and exchanged with the one or more client devices 106 via the communication path 112. The network component 102 may include the one or more processors 120, a memory 170, an input (I)/output (O) interface 130, a communication interface 140, and storage and databases 150 connected to one another via an interconnect 160. The network component 102 may be a computer system used to provide routing and assignment of resources during data packet transmissions. In one or more embodiments, one or more memory elements (e.g., the memory 170) may be shared by the one or more processors 120 in the network component 102. The one or more processors 120 in the network component 102 may be adapted to perform basic and advanced packet counting and forwarding operations. Although this disclosure describes and illustrates a particular network component 102 having a particular number of particular components in a particular arrangement, this disclosure contemplates any suitable network component 102 or computer system having any suitable number of any suitable components in any suitable arrangement.

In some embodiments, the network component 102 may take any suitable physical form. As example and not by way of limitation, the network component 102 may be an embedded computer system, a system-on-chip (SOC), a single-board computer (SBC) system (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, a router device, or a combination of two or more of these. Where appropriate, the network component 102 may include one or more computer systems; be unitary or distributed; span multiple locations; span multiple machines; span multiple data centers; or reside in a cloud, which may include one or more cloud components in one or more networks. Where appropriate, one or more computer systems may perform without substantial spatial or temporal limitation one or more steps of one or more methods described or illustrated herein. As an example, and not by way of limitation, the network component 102 may perform in real-time or in batch mode one or more steps of one or more methods described or illustrated herein. The network component 102 may perform at different times or at different locations one or more steps of one or more methods described or illustrated herein, where appropriate.

In some embodiments, the one or more processors 120 includes hardware for executing instructions, such as those making up a computer program. As an example, and not by way of limitation, to execute instructions, the one or more processors 120 may retrieve (or fetch) the instructions from an internal register, an internal cache, or the memory 170; decode and execute them; and then write one or more results to an internal register, an internal cache, or the memory 170. Specifically, the one or more processors 120 may include one or more internal caches for data, instructions, or addresses. This disclosure contemplates the one or more processors 120 including any suitable number of internal caches, where appropriate. As an example, and not by way of limitation, the one or more processors 120 may include one or more instruction caches, one or more data caches, and one or more translation lookaside buffers (TLBs). Instructions in the instruction caches may be copies of instructions 172 in the memory 170, and the instruction caches may speed up retrieval of those instructions by the one or more processors 120. Data in the data caches may be copies of data in the memory 170 for instructions executing at the one or more processors 120 to operate on via one or more processing engines 128; the results of previous instructions executed at the one or more processors 120 for access by subsequent instructions executing at the one or more processors 120 or for writing to the memory 170; or other suitable data. The data caches may speed up read or write operations by the one or more processors 120. The TLBs may speed up virtual-address translation for the one or more processors 120. In particular embodiments, the one or more processors 120 may include one or more internal registers for data, instructions, or addresses. This disclosure contemplates the one or more processors 120 including any suitable number of suitable internal registers, where appropriate. Where appropriate, the one or more processors 120 may include one or more arithmetic logic units (ALUs); be a multi-core processor; or include one or more additional one or more processors 120. Although this disclosure describes and illustrates a particular processor, this disclosure contemplates any suitable processor.

In one or more embodiments, the one or more processors 120 include hardware, software executed by hardware, or a combination of both, providing one or more service components to route and assign resources for data packet transmissions. The one or more processors 120 may include access to the one or more application layers 122, one or more collectors 124, one or more scanners 126, and one or more processing engines 128 communicatively coupled to one another or interconnected via a transmission bus (not shown, but similar to the interconnect 160 described below). The one or more processors 120 may be a routing device configured to route resources in the network 104 to the one or more client devices 106. In some embodiments, the one or more processors 120 may be included on a same card or die. In this regard, the access to the application layers 122 may comprise one or more access to multiple assets 123 performing one or more operations in an application. The collectors 124 and the scanners 126 may be configured to retrieve one or more asset parameters from the one or more application layers 122. The asset parameters may comprise information indicating monitored statuses for each of the application layers 122. The collectors 124 and the scanners 126 may be centralized or distributed (e.g., deployed under control of asset owners, application controls, or application management). In some embodiments, collectors 124 and the scanners 126 support continuous scanning and/or collection capability both in an active mode and a passive mode. In one example, the asset parameters may be signals collected or scanned during one or more run time environments (e.g., active mode). In another example, the asset parameters may be signals collected by importing files (e.g., passive mode) or through application programming interfaces (APIs). In yet another example, the asset parameters may be signals obtained in multiple ways, such as by scanning via a plugin interface or collected via an upload process or operation.

In other embodiments, the one or more processing engines 128 may be software executed by hardware and configured to determine attack paths to application assets 123 based at least in part on the asset parameters obtained from the application layers 122. The one or more processing engines 128 are described in more detail in reference to FIG. 2. The one or more processing engines 128 may be implemented by the one or more processors 120 operating as specialized hardware accelerators. The one or more processing engines 128 may be configured to implement networking-specific processing tasks in custom logic and achieve better performance than typical software implementations. For example, the one or more processing engines 128 may be lookup engines (e.g., using specialized logic), cryptographic coprocessors, content inspection engines, and the like. In some embodiments, the one or more processing engines 128 comprise a layer status engine 210, a security resources engine 220, an asset analysis engine 240, an attack path determination engine 270, and an attack path analysis engine 292.

In one or more embodiments, the I/O interface 130 comprises hardware, software executed by hardware, or a combination of both, providing one or more interfaces for communication between the network component 102 and one or more I/O devices. The network component 102 may include one or more of these I/O devices, where appropriate. One or more of these I/O devices may enable communication between a person and the network component 102. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. This disclosure contemplates any suitable I/O devices and any suitable I/O interfaces 130 for them. Where appropriate, I/O interface 130 may include one or more device or software drivers enabling the one or more processors 120 to drive one or more of these I/O devices. The I/O interface 130 may include one or more I/O interfaces 130, where appropriate. Although this disclosure describes and illustrates a particular I/O interface 130, this disclosure contemplates any suitable I/O interface 130.

In one or more embodiments, the communication interface 140 includes hardware, software executed by hardware, or a combination of both providing one or more interfaces for communication (such as, for example, packet-based communication) between the network component 102, the one or more client devices 106, the network 104, or one or more additional networks. As an example, and not by way of limitation, the communication interface 140 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable corresponding communication interface 140. As an example, and not by way of limitation, the network component 102 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the network component 102 may communicate with a wireless PAN (WPAN) (such as, for example, a Bluetooth WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. The network component 102 may include any suitable communication interface 140 for any of these networks, where appropriate. The communication interface 140 may include one or more communication interfaces 140, where appropriate. Although this disclosure describes and illustrates a particular communication interface, this disclosure contemplates any suitable communication interface.

In some embodiments, the storage and databases 150 may be communicatively coupled to the one or more processors 120, the I/O interfaces 130, the communication interfaces 140, and the memory 170. The storage and databases 150 may be a wired connection that shares an internal bandwidth for data packet transmissions inside the network component 102 with the memory 170. The storage and databases 150 may be configured with an internal buffering capacity and an internal memory speed. The internal buffering capacity may indicate a buffering capacity (in bytes) that the storage and databases 150 are capable of handling. For example, the internal buffering capacity may be 1,000 bytes. Further, the internal memory speed may indicate a processing speed (in bytes per second) at which the storage and databases 150 is capable of handling or buffering data packets. For example, the internal memory speed may be 1,000 bytes per second. The storage and databases 150 may comprise instructions and data memory for the one or more processors 120. In other embodiments, some portions of the memory are shared among the one or more processors 120 and the memory 170. The storage and databases 150 may comprise one or more attack paths 155 representative of a sequence of vulnerable assets 123 that an attack vector may follow to impact the integrity of the application. Each attack path of the attack paths 155 may be configured to provide visibility and understanding of vulnerable assets 123 across the multiple application layers 122.

In particular embodiments, the interconnect 160 includes hardware configured to couple components of the network component 102 to each other. As an example and not by way of limitation, the interconnect 160 may include an Accelerated Graphics Port (AGP) or a graphics bus, an Enhanced Industry Standard Architecture (EISA) bus, a front-side bus (FSB), a HyperTransport (HT) interconnect, an Industry Standard Architecture (ISA) bus, an InfiniBand interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The interconnect 160 may include one or more interconnect 160, where appropriate. Although this disclosure describes and illustrates a particular bus, this disclosure contemplates any suitable bus or interconnect.

The interconnect 160 may be one or more memory buses (which may each include an address bus and a data bus) that may couple the one or more processors 120 to the memory 170. In other embodiments, one or more memory management units (MMUs) reside between the one or more processors 120 and the memory 170 and facilitate accesses to the memory 170 requested by the one or more processors 120. In particular embodiments, the memory 170 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. The memory 170 may include one or more additional memories, where appropriate. Although this disclosure describes and illustrates particular memories, this disclosure contemplates any suitable memory or combination of suitable memories.

In particular embodiments, the memory 170 includes mass storage for data or instructions. As an example, and not by way of limitation, the memory 170 may include a hard disk drive (HDD), a floppy disk drive, flash memory, an optical disc, a magneto-optical disc, magnetic tape, or a Universal Serial Bus (USB) drive or a combination of two or more of these. The memory 170 may include removable or non-removable (or fixed) media, where appropriate. The memory 170 may be internal or external to a computer system, where appropriate. In particular embodiments, the memory 170 is non-volatile, solid-state memory. In particular embodiments, the memory 170 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates the memory 170 as a mass storage taking any suitable physical form. The memory 170 may include one or more storage control units facilitating communication between the one or more processors 120 and the memory 170, where appropriate. Although this disclosure describes and illustrates particular storage, this disclosure contemplates any suitable storage.

In one or more embodiments, the memory 170 includes a main memory for storing the instructions 172 for the one or more processors 120 to execute or data for the one or more processors 120 to operate on. As an example, and not by way of limitation, the network component 102 may load the instructions 172 from another memory in the network component 102. The one or more processors 120 may then load the instructions 172 from the memory 170 to an internal register or internal cache. To execute the instructions 172, the one or more processors 120 may retrieve the instructions 172 from the internal register or internal cache and decode them. During or after execution of the instructions 172, the one or more processors 120 may write one or more results (which may be intermediate or final results) to the internal register or internal cache. The one or more processors 120 may then write one or more of those results to the memory 170. In some embodiments, the one or more processors 120 executes only the instructions 172 in one or more internal registers or internal caches or in the memory 170 and operates only on data in one or more internal registers or internal caches or in the memory 170.

In one or more embodiments, the memory 170 includes commands or data associated with one or more specific applications in addition or as part of the instructions 172. In FIG. 1, the memory 170 comprises the one or more asset controls 174, multiple rules and policies 176, asset mapping information 178, asset discovery 180, asset inventory 182, asset classification 184, attack path analysis information 186, asset topology 190, attack vectors 192, one or more weighted costs 194, and security and safety information 196. In some embodiments, the one or more asset controls 174 may be configured to provide one or more connectivity parameters to establish a connection between the one or more processors 120 and the application layers 122. The one or more asset controls 174 may be configured to provide access to assets 123 in the application layers 122. For example, the one or more asset controls 174 may be one or more preestablished commands that the collectors 124 and the scanners 126 may use to obtain the monitoring statuses from the application layers 122.

In some embodiments, the multiple rules and policies 176 may be information commanding rules and/or operations of the system 100. The rules and policies 176 may be updated dynamically or periodically over time. For example, the rules and policies 176 may provide guidelines to access, receive and transmit information using the network component 102. In other embodiments, the asset mapping information 178 comprises mapping tools that enables mapping of assets 123 in the application layers 122 when implemented by the one or more processors 120. The asset discovery 180 may be information to find existing assets 123 in the application layers 122. The asset inventory 182 may be configured to provide information indicating names or identifiers for the assets 123 in the application layers 122. The asset classification 184 may be configured to provide relation information between the assets 123 and any corresponding application layers 122.

In one or more embodiments, the attack path analysis information 186 may be configured to provide attack path information generated via the one or more processing engines 128. In some embodiments, the attack path analysis information 186 is the basis to analyze the attack paths 155 and any corresponding impact to one or more assets 123 in the application layers 122. In other embodiments, the attack path analysis information 186 may be risk associated factors indicating a level or risk associated with any one segment of a specific attack path 155. In some embodiments, the asset topology 190 may be configured to associate assets 123 among one another. For example, the asset topology 190 may comprise relation information among one or more assets 123. The asset topology 190 may be dynamically modified based at least in part upon changes to operations or structures in the application layers 122 of the application.

In some embodiments, the attack vectors 192 may be configured to represent a sequence of vulnerabilities that may be exploited by bad actors (e.g., attackers or hackers) to gain access to application assets 123 in order to deliver a payload or a malicious outcome (e.g., exfiltrate data, ransomware, or cyberattacks against the application). Each vulnerability may be seen as an attack vector or an element of an attack vector 192. In certain embodiments, a vulnerability may be part of several attack vectors 192. The attack vectors 192 may be unencrypted data from data security posture management (DSPM). In other embodiments, the attack paths 155 are visual representations of specific chains of actions or events that may occur when the attack vectors 192 are exploited in a given application instance and configuration context.

In some embodiments, the one or more weighted costs 194 may be configured to represent a difficulty for an attacker to make a transition between any two assets by exploiting a detected attack vector 192. A higher weighted cost 194 may represent a higher difficulty to transition between assets and a lower weighted cost 194 may represent a lower difficulty to transition between the assets. Further, the weighted costs 194 may be configured to represent monetary or organizational impacts resulting from unsanctioned access to the assets 123 to the application. The weighted costs 194 may be different or the same for different segments of a given attack path 155. Further, the weighted costs may be different or the same for different attack paths 155. For example, a first attack path of the attack paths 155 may comprise multiple segments. In this case, each segment may comprise a corresponding weighted cost 194. The security and safety information 196 may be a database comprising knowledge of tactics and techniques designed for threat hunters, defenders and red teams to classify attacks, identify attack attribution and objectives, and assess risks for a given organization. In some embodiments, the given organization may use a framework to identify security gaps and prioritize mitigations based on the assessed risks.

One or more of the asset controls 174, the rules and policies 176, the asset mapping information 178, the asset discovery 180, the asset inventory 182, the asset classification 184, the attack path analysis information 186, the asset topology 190, the attack vectors 192, the weighted costs 194, and the security and safety information 196 may be configured to be used or updated as part of the operational flow 200 described in reference to FIG. 2.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In one or more embodiments, the network 104 may be a combination of electronic devices forming a multi-node mesh. As an example and not by way of limitation, one or more portions of the network 104 may include an ad hoc network, an intranet, an extranet, a virtual private network (VPN), a LAN, a wireless LAN (WLAN), a WAN, a wireless WAN (WWAN), a MAN, a portion of the Internet, a portion of the Public Switched Telephone Network (PSTN), a cellular technology-based network, a satellite communications technology-based network, another network 104, or a combination of two or more such networks 104.

In one or more embodiments, the one or more client devices 106 include end-user devices such as laptops, phones, tablets, and any other suitable device that are capable of receiving, creating, processing, storing, or communicating information, including data packet transmissions. The client devices 106 may comprise one or more network interfaces, at least one processor, and a memory that is interconnected by a system bus as well as a power supply. In some embodiments, the client devices 106 represents devices that are capable of receiving real-time data packet transmissions and may include general purpose computing devices (e.g., servers, workstations, desktop computers, and the like), mobile computing devices (e.g., laptops, tablets, mobile phones, and the like), wearable devices (e.g., watches, glasses, or other head-mounted displays (HMDs), ear devices, and the like), and so forth. The client devices 106 may also include Internet of Things (IoT) devices or equipment, such as agricultural equipment (e.g., livestock tracking and management systems, watering devices, unmanned aerial vehicles (UAVs), and the like); connected cars and other vehicles; smart home sensors and devices (e.g., alarm systems, security cameras, lighting, appliances, media players, Heating Ventilation, and Air Conditioning (HVAC) equipment, utility meters, windows, automatic doors, door bells, locks, etc.); office equipment (e.g., desktop phones, copiers, fax machines, and the like); healthcare devices (e.g., pacemakers, biometric sensors, medical equipment, and the like); industrial equipment (e.g., robots, factory machinery, construction equipment, industrial sensors, and the like); retail equipment (e.g., vending machines, point of sale (POS) devices, Radio Frequency Identification (RFID) tags, and the like); smart city devices (e.g., street lamps, parking meters, waste management sensors, and the like); transportation and logistical equipment (e.g., turnstiles, rental car trackers, navigational devices, inventory monitors, and the like); and so forth.

FIG. 2 shows an example operational flow 200 to determine attack paths 155 to application assets 123 associated with one or more application layers 122 in the system 100 of FIG. 1, in accordance with one or more embodiments. In FIG. 2, the operational flow 200 is performed by different components in the network component 102. In particular, the operational flow 200 may be performed using the one or more processors 120. As a non-limiting example, the communication interface 140 may be a source of data packet transmissions into the network component 102 via the communication path 110 and the communication path 112. The communication interface 140 may also transfer data packet transmissions outside from the network component 102 via the communication path 110 and the communication path 112. In some embodiments, the operational flow 200 is performed via implementation of the one or more processing engines 128, which may comprise a layer status engine 210, a security resources engine 220, an asset analysis engine 240, an attack path determination engine 270, and an attack path analysis engine 292 communicatively coupled to one another. As described above, the layer status engine 210, the security resources engine 220, the asset analysis engine 240, the attack path determination engine 270, and the attack path analysis engine 292 may be implemented via the one or more processors 120.

The layer status engine 210 may be configured to retrieve monitored statuses collected and scanned via the collectors 124 and the scanners 126, respectively. The collectors 124 and the scanners 126 may be configured to track vulnerabilities from the assets 123 in the application layers 122. In the example of FIG. 2, the collectors 124 and the scanners 126 monitor statuses of the assets 123A in the application data layer 122A; the assets 123B in the application logic layer 122B; the assets 123C in the application infrastructure layer 122C; and the assets 123D in the application cloud infrastructure layer 122D. The layer status engine 210 may be configured to establish one or more security updates 216 with the security resources engine 220. In this regard, the layer status engine 210 may be configured to provide layer statuses 214 to the asset analysis engine 240 based at least in part upon the security updates 216 established with the layer status engine 210.

In one or more embodiments, the security resources engine 220 comprises the rules and policies 176, one or more risk prioritization levels 222, and one or more attack sources 224. The security resources engine 220 may be configured to establish the security updates 216 with the layer status engine 210 based at least in part upon the rules and policies 176. The risk prioritization levels 222 may be configured to provide a prioritization for a vulnerable asset 123 in the application. For example, the risk prioritization levels 222 may indicate a relevance of one or more assets 123 to the overall application or to one of the application layers 122. In another example, security resources engine 220 may indicate a first prioritization level 222 for a first vulnerable asset 123 comprising access to databases with personally identifiable information (PII) and a second prioritization level 222 for a second vulnerable asset 123 comprising a breach to steal CPU (e.g., CPU steal time for cryptomining). The attack sources 224 may be indicative of possible starting points for one or more of the attack vectors 192. In some embodiments, the security resources engine 220 may be configured to provide asset protection information 226 to the attack path determination engine 270 based at least in part upon the security updates 216 established with the layer status engine 210. The asset protection information 226 may comprise the risk prioritization levels 222 in association with one or more of the attack sources 224. The asset analysis engine 240 may be configured to generate multiple attack vector parameters 242 based at least in part upon the asset controls 174, the asset discovery 180, the asset inventory 182, the asset classification 184, the attack vectors 192, and the weighted costs 194.

The attack path determination engine 270 may be configured to determine attack paths to one or more of the application assets 123. The attack path determination engine 270 may receive the attack vector parameters 242 from the asset analysis engine 240, one or more security parameters 252 from a MITRE ATT&CK framework 250, one or more security contributions 262 from one or more security expert contributors 260, and the asset protection information 226 from the security resources engine 220. The attack vector parameters 242 may be configured to indicate vulnerabilities of one or more of the plurality of application assets.

The MITRE ATT&CK framework 250 may be associated with MITRE ATT&CK®, which stands for MITRE Adversarial Tactics, Techniques, and Common Knowledge (ATT&CK). The MITRE ATT&CK framework 250 is a curated knowledge base and model for cyber adversary behavior, reflecting various phases of attack lifecycles and attack targets for bad actors. The MITRE ATT&CK framework 250 may provide a common taxonomy of individual adversary actions by both offensive and defensive sides of cybersecurity. Further, the security contributions 262 may comprise additional information for identifying tactics and techniques such as reconnaissance, resource development, initial access, execution, persistence, privilege escalation, defense evasion, credential access, discovery, lateral movement, collection, command and control, exfiltration and impact tactics and techniques. As non-limiting examples, the reconnaissance tactics and techniques may involve bad actors actively or passively gathering information that could be used to support targeting. The resource development tactics and techniques may involve bad actors creating, purchasing, or compromising/stealing resources that could be used to support targeting. The initial access tactics and techniques may comprise gaining initial footholds within the network 104 via targeted spearphishing and exploiting weaknesses on public-facing assets 123. The execution tactics and techniques may comprise adversary-controlled code running on a local or a remote system paired with techniques from all other tactics to achieve broader goals, like exploring a network or stealing data. The persistence tactics and techniques may comprise techniques that bad actors may use to keep access to systems across restarts, changed credentials, and other interruptions that could cut off access to the bad actors. The privilege escalation tactics and techniques may comprise bad actors attempting to gain higher-level permissions on a system or network. The defense evasion tactics and techniques may be comprise bad actors attempting to avoid detection throughout attacks. The credential access tactics and techniques may comprise bad actors attempting to steal credentials or access information like account names and passwords. The discovery tactics and techniques may comprise bad actors attempting to gain knowledge about internal architectures of systems and networks. The lateral movement tactics and techniques may comprise bad actors that attempt to enter and control remote systems on a network. The collection tactics and techniques may comprise bad actors attempting to gather information from the application. The command and control tactics and techniques may comprise bad actors that communicate with systems under a guise of management and control. The exfiltration tactics and techniques may comprise bad actors attempting to steal data from the application. The impact tactics and techniques may comprise bad actors attempting to disrupt availability or compromise integrity of operational processes in the application.

The security expert contributors 260 may be one or more contributions from security organizations comprising expertise in the areas of application defense and cybersecurity among others. The security expert contributors 260 may be configured to provide additional insight to application security operations based at least in part ongoing advances in cybersecurity applications. Further, the one or more security contributions 262 may be one or more commands or guidance to implement in the attack path determination engine 270. In this regard, the security expert contributors 260 may provide changes or definitions to cyberattack issues based on specific findings. These changes or definitions may comprise modifying sensitive asset inventories, or detecting and configuring additional issues or weaknesses in the application layers 122, among others.

In one or more embodiments, the attack path determination engine 270 may perform multiple operations 272-288 comprising multiple feasibility parameters 294 that are dynamically or periodically updated in accordance with the attack vector parameters 242, the security parameters 252, the security contributions 262, and the asset protection information 226. The attack path determination engine 270 may determine a current version of the feasibility parameters 294 based at least upon the attack vector parameters 242. The attack path determination engine 270 may provide the feasibility parameters 294 to an inference engine via operation 272. At the inference engine 274, the attack path determination engine 270 may be configured to determine filtering commands to be provided via the operation 282 to update the asset mapping information 178. The filtering commands may associate relevant assets 123 in one layer to vulnerable assets 123 one of the other application layers 122. The attack path determination engine 270 may be configured to determine identify, categorize, and map possible attack vectors 192 both within and across application layers 122 and provide the mapped attack vectors 192 via the operation 276 to update the asset topology 190.

In one or more embodiments, the attack path determination engine 270 may update the feasibility parameters 294 via the operation 280, the operation 282, and the operation 284 based at least in part upon the updated asset mapping information 178 and via the operation 280, the operation 276, and the operation 278 based at least upon the updated asset topology 190. At this stage, the attack path determination engine 270 may be configured to perform operations 286 and 288 with the attack path analysis engine to determine threat prioritization parameters 296 and threat remediation parameters 298 based at least in part upon the updated feasibility parameters 294 and the attack paths 155. In some embodiments, the threat prioritization parameters 296 are configured to indicate first corresponding priorities for each vulnerable asset in the first plurality of vulnerable assets or in a given attack path. In other embodiments, the threat remediation parameters 298 are configured to indicate a first solution to remediate the first attack path in the system.

In the example of FIG. 2, the attack path determination engine 270 may be configured to determine and update the attack paths 155 to vulnerable application assets 123. The application layers 122 may comprise an application data layer 122A, an application logic layer 122B, an application infrastructure layer 122C, and an application cloud infrastructure layer 122D.

In some embodiments, the rules and policies 176 may comprise application security solutions, and one or more trusted entities (e.g., Common Vulnerabilities and Exposures (CVEs)) among one or more additional source. The asset analysis engine 240 may further comprise a data discovery module (e.g., a managed and/or unmanaged data stores), asset classification modules, asset inventory modules, risk quantification tools (e.g., as represented in currency), and access from on-call security experts.

In the attack path determination engine 270, the feasibility parameters 294 may be retrieved from the storage and databases 150. In certain embodiments, the attack path analysis engine 292 may comprise the threat prioritization parameters 296 and the threat remediation parameters 298 to implement as threat prioritization and remediation actions, respectively. In certain embodiments, each of the attack vectors 192 may represent a single vulnerability or a sequence of vulnerabilities that may be exploited by a bad actor (e.g., an attacker or hacker) to gain access to one or more assets 123 in order to deliver a payload or a malicious outcome (e.g., exfiltrate data, ransomware, DoS attacks against the application, and the like). Each vulnerability may be seen as an element of a given attack vector 192. In some embodiments, a vulnerability may be part of several attack vectors 192. In this regard, an attack path 155 is a visual representation of a specific chain of actions or events that may occur when attack vectors 192 are exploited in a given application instance and configuration context.

In the operational flow 200 of FIG. 2, multiple input signals to the attack path determination engine may be obtained from one or more of the collectors 124 and the scanners 126. Each of the collectors 124 and the scanners 126 may obtain signals from assets 123A-123D from each application layer of the multiple application layers 122. Attacks may occur by exploiting vulnerabilities across these four layers. In some embodiments, the application data layer 122A comprises the assets 123A responsible for asset controls, classification, conformance and compliance, application modeling for anomaly detection, testing, AI/ML, and the like. In certain embodiments, the application logic layer 122B comprises the assets 123B responsible for API logic, serverless logic, application software, application modeling for anomaly detection, testing, AI/ML, and the like. In some embodiments, the application infrastructure layer 122C comprises the assets 123C responsible for Kubernetes protection, virtual machine (VM) scanning, CVEs, Common Weakness Enumerations (CWEs), serverless posture, images, Software Bill of Materials (SBOM), Secure Supply Chain (SSC), Software Licensing Supply Arrangement (SLSA), Infrastructure as code (IaC), Continuous Integration and Continuous Delivery (CICD), and the like. In certain embodiments, the application cloud infrastructure layer 122D comprises the assets 123D responsible for cloud security posture, agentless and full security scanning, identity and entitlement, and the like.

In one or more embodiments, the collectors 124 and the scanners 126 are centralized (e.g., deployed in the assets 123C in the application infrastructure layer 122C under control of an asset owner or manager)or distributed (e.g., deployed in the assets 123D in the application cloud infrastructure layer 122D under control of the asset owner or manager). In some embodiments, the collectors 124 and the scanners 126 support continuous or periodic scanning and/or collection capability both in active and passive mode. For example, some signals may require scanning run time environments (e.g., active mode). In another example, some may signals be collected by importing files (e.g., passive mode) or through application programming interfaces (APIs) or other means. In still another example, some signals may be obtained in various ways, such as by scanning via a plugin or collected via an upload process.

In certain embodiments, the signals are used to build the application service topology. For example, topology may be imported from the asset owner (e.g., in JSON), application security solution (e.g., Panoptica™), an Application and Performance Monitoring (APM) (e.g., Cisco AppD or Datadog™), Continuous Integration (CI) tools, and the like. In another example, signals at build time may come from IaC, API specifications, SBOM, code scanners, configs, and the like. In still another example, signals at run time may come from Cloud Infrastructure Entitlement Management (CIEM), Cloud Security Posture Management (CSPM), OpenTelemetry™, security resources engine 220 (e.g., Panoptica™), API security, container security, serverless security, virtual machine (VM) security, a human in the loop, and the like.

In some embodiments, the collectors 124 and the scanners 126 scans and/or collects signals from the application data layer 122A, the application logic layer 122B, the application infrastructure layer 122C, the application cloud infrastructure layer 122D, trusted entities (e.g., to retrieve CVEs), or other sources. Example signals that may be used to build the data topology include scanners and collectors in the data layer (e.g., connectors to a specific database, such as mongoDB or mySQL). Such signals may feed the layer statuses 214 to the asset analysis engine 240, which in turn may feed the attack vector parameters 242 to the attack path determination engine 292, thereby enabling the creation of asset inventory 182 for the different categories of sensitive assets handled by the applications (e.g., for PII, Payment Card Industry (PCI), confidential data, and the like).

In one or more embodiments, the attack path determination engine 270 is configured to extract example signals to generate the attack vector parameters at least in part upon the asset controls 174, the asset discovery 180, the asset inventory 182, the asset classification 184, the attack vectors 192, and the weighted costs 194, which depend on the type and quantity of data that might be exposed.

In one or more embodiments, an operational flow 200 comprises determining attack paths 155 to the application assets 123 and include one or more of the operations 272-288. At operation 272, the attack vector parameters 242 are used as inputs to the inference engine 274. The inference engine 274 may be configured to generate inferences. In certain embodiments, the inference engine 274 may apply different techniques to reason on the data gathered, such as ontological knowledge, semantic relatedness, and the like.

At operation 276, one of the techniques may comprise computation and inference of an application service topology along with a binding and/or mapping process between the data topology and the application service topology inferred. Hence, in application service data topology, a converged topological view may be available for the application as the updated asset topology 190. In certain embodiments, one or more different filtering techniques may be implemented in order to understand where specific categories of sensitive data sit at rest and/or asset relation flows across the application services. At operation 278, the updated asset topology 190 is persisted in the storage and database 150. At operation 280, the inference engine 274 uses this topological view as a new input based at least in part upon the feasibility parameters 294.

At operation 282, the inference engine 274 applies another technique to identify, categorize, and/or map the possible attack vectors 192 both within and across the application layers 122A-122D to the application service and/or data instance. In some embodiments, a comprehensive list of the attack vectors 192 might be known and available in advance via the memory 170 or the storage and databases 150, so this operation may focus on identifying which of those attack vectors 192 are present in a specific app service and data instance. In some embodiments, the inference engine 274 may start from the vulnerabilities and potential intrusions found in the instance (e.g., fed to the storage and databases 150), and then compute the possible attack vectors 192 based at least in part upon such vulnerabilities. The outcome may be compared against a set of known/common attack vectors 192. In case of difference between the attack vectors 192 found and those that were listed and known beforehand, the list of attack vectors 192 may be updated.

At operation 284, the list of attack vectors 192 mapped in the updated asset mapping information 178 may be persisted for the feasibility parameters 294 at the storage and databases 150. At operation 286, the application service and data topology along with the relevant attack vectors 192 found is used as an input by attack path analysis engine 292. In certain embodiments, the attack path analysis engine 292 may determine whether the feasible parameters 294 indicate that the attack paths 155 comprise vulnerable assets. Such analysis may include the identification of critical threats, prioritization, and/or enumeration of detailed steps allowing remediation actions to eliminate such threats. At operation 288, results of the attack path analysis performed by the attack path analysis engine 292 are persisted in the storage and databases 150. In certain embodiments, the attack path determination engine may check whether any critical attack paths 155 were remediated. To dynamically determine and prioritize threats, operations 286 and 288 may run continuously or periodically, which may allow for a closed-loop analysis and remediation without requiring manual triggers of any data or application service scanning process.

FIG. 3 shows an example attack path analysis 300, in accordance with one or more embodiments. The attack path analysis 300 may be performed by the attack path analysis engine to establish one or more threat prioritization parameters 296 or threat remediation parameters 298 for the attack paths 155. In the example of FIG. 3, the one or more processors 120 comprise the collectors 124 and the scanners 126 communicatively coupled to the application data layer 122A, the application logic layer 122B, the application infrastructure layer 122C, and the application cloud infrastructure layer 122D. The attack path analysis 300 may comprise identifying one or more attack vectors 192. In the example of FIG. 3, multiple vulnerable assets 302 are shown to include an asset 123AA, an asset 123AB, an asset 123BA, an asset 123CA, an asset 123DA, and an asset 123DB. The asset 123DB is shown associated to the asset 123DA. The asset 123DA is shown associated to the asset 123CA and the asset 123AB. The asset 123BA is shown associated with the asset 123AA and the asset 123AB.

In some embodiments, example attack vectors 192 comprise entry points for vulnerabilities between the asset 123DB and the asset 123AB; between the asset 123DB and the asset 123BA; between the asset 123DB, the asset 123BA, and the asset 123AB; and between the asset 123DB, the asset 123BA, and the asset 123AA. In the attack path analysis 300 of FIG. 3, the application cloud infrastructure layer 122D comprises a weak password vulnerability (e.g., breach password and privilege escalation) shown as the asset 123DB and a role/entitlement (admin) vulnerability shown as the asset 123DA. The application infrastructure layer 122C may comprise a related vulnerability in, for example, a container admin command spin up command & control (C2) shown as the asset 123CA. The vulnerability at the asset 123DA may enable access to the asset 123AB or the asset 123CA. At the application logic layer 122B, the vulnerabilities may comprise a CVE in a given API. The asset 123AA and the asset 123AB may be accessed from the asset 123BA. In the example of FIG. 3, the application data layer 122A comprises unencrypted PII in MongoDB as a vulnerability shown in the asset 123AA and an unencrypted PCI in S3 bucket as a vulnerability shown in the asset 123AB. This example may be used by the attack path analysis engine 292 to compute attack paths 155 and remediation actions for these attack paths 155. As described above, an attack path 155 may comprise multiple segments. In other embodiments, a first attack path may be from the asset 123DB to the asset 123AB via the asset 123DA; a second attack path may be from the asset 123DB to the asset 123AA via the asset 123DA and the asset 123BA; and a third attack path may be from the asset 123DB to the asset 123AB via the asset 123DA and the asset 123BA.

In one or more embodiments, as part of the attack path analysis 300, the one or more processors 120 implementing the attack path analysis engine 292 may be configured to assign weighted costs 194 to any visual representation of the vulnerable assets 302 (e.g., to the edges). Each weighted cost 194 may comprise a difficulty to transition between any two assets 123 and a risk-cost associated with the impact of bad actors accessing a given asset in the application layers 122. For example, to model the difficulty for an attacker to make a transition between two nodes in the graph (e.g., to successfully carry out the action represented by the edge). In this regard, the attack path analysis 300 may comprise determining whether the attack vectors 192 are feasible as vulnerable entry points into the application layers 122 and are labeled for computing the least resistant attack path to reach the data asset. For instance, a node representing the action “C2 starts with App” may require an attacker to first get C2 into the application code. Hence, not every asset is a feasible source for attack path computation.

There are novel elements to this since this goes beyond reducing false positives. For instance, it considers whether a source node in a DAG is a feasible starting point for an attack path and may discard it as a source and/or augment dynamically the graph as needed to cover this. For instance, a command & control (C2) instance cannot be the source of an attack path, since an attacker would first need other means (e.g., poison the code, the CICD pipeline, etc.) to spin up C2.

In one or more embodiments, the attack path analysis 300 computes minimum cost paths for each attackable data asset from every feasible source node in the graph. In certain embodiments, the attack path analysis 300 comprises selecting a least resistant (e.g., minimum cost) attack path 155 to breach unencrypted PCI in a managed S3 bucket. At this stage, the attack path analysis 300 comprises prioritizing threats and enumerating any required remediation actions, persist existing the results, of ending the analysis. In the example of FIG. 3, weighted costs 310-340 are shown as different costs associated with vulnerability accesses from one asset to another. For example, a first path from the asset 123DB to the asset 123DA comprises the weighted cost 350, a second path from the asset 123DA to the asset 123AB comprises the weighted cost 340, a third path from the asset 123DA to the asset 123CA comprises the weighted cost 330, a fourth path from the asset 123CA to the asset 123BA comprises the weighted cost 320, a fifth path from the asset 123BA to the asset 123AA comprises the weighted cost 310, and a sixth path from the asset 123BA to the asset 123AB also comprises the weighted cost 310.

FIG. 4 shows an example flowcharts of a process to determine attack paths to application assets associated with one or more application layers in a multi-layer application, in accordance with one or more embodiments. Modifications, additions, or omissions may be made to the process 400. The process 400 may include more, fewer, or other operations than those shown below. For example, operations may be performed in parallel or in any suitable order. While at times discussed as the network component 102, the one or more processors 120, or components of any of thereof, any suitable system or components of the system 100 may perform one or more operations of the process 400. For example, one or more operations of process 400 may be implemented, at least in part, in the form of software instructions 172 of FIG. 1, stored on non-transitory, tangible, machine-readable media (e.g., memory 170 of FIG. 1) that when run by one or more processors (e.g., one or more processors 120 of FIG. 1) may cause the one or more processors to perform operations described in operations 402-430.

The process 400 starts at operation 402, where the one or more processors 120 obtain current attack vectors 192 from the storage and databases 150. The process 400 continues at operation 410, where the one or more processors 120 determine whether the attack vectors 192 comprise any updates. If the attack vectors 192 do not comprise any updates (e.g., NO), the process 400 continues to operation 430. If the attack vectors 192 comprise one or more updates (e.g., YES), the process 400 proceeds to operation 412. At operation 412, the one or more processors 120 determine vulnerable assets from the current attack vectors 192. At operation 414, the one or more processors 120 generate a visualization interface. At operation 416, the one or more processors 120 present the visualization interface in a display or other I/O interface 130.

As shown in the visualization 450, a PII 440 and a PCI 444 are identified as target assets 123 vulnerable via one or more attack paths 155. Following as a non-limiting example of the discussion of FIG. 3, the asset 123DB may be a starting point for attack paths 155 reaching to the PII 440 and the PCI 444. The attack paths 155 may proceed to the asset 123BA or the asset 123AB. Further, from the asset 123BA. The attack paths may further branch out to asset 123AA and the asset 123AB. From the asset 123AA, one of the attack paths 155 may reach the PII 440. From the asset 123AB, another of the attack paths 155 may reach the PCI 444. The visualization 450 may be a directed acyclic graph (DAG) that is updated dynamically or periodically over time.

The process 400 continues at operation 418, where the one or more processors 120 determine the one or more attack paths 155. At operation 420, the one or more processors 120 update the visualization interface. At operation 422, the one or more processors 120 assign weighted costs 194 to transitions between any two vulnerable assets 123 in the attack paths 155. For example, at operation 422, the process 400 assigns weighted costs 194 to the edges of the DAG At operation 424, the one or more processors 120 determine the feasibility for each of the vulnerable assets 123 based at least in part upon the updated feasibility parameters 294 as updated by the attack path determination engine 270. At operation 426, the one or more processors 120 calculate the weighted costs 194 for transitions between any two assets 123 in multiple attack paths 155. For example, at operation 426, the process 400 determines total weighted costs 194 for each attack path 155 identified in the DAG. At operation 428, the one or more processors 120 prioritize threats and enumerate remediation actions for each of the attack paths 155.

As shown in the visualization 452, attack paths 155 from the asset 123DB to the PII 440 or the PCI 444 may be assigned different intermediate vulnerable assets 123 in accordance with the one or more feasibility parameters 294 (e.g., shown as a first feasibility parameter 294A and a second feasibility parameter 294B. Further, in the visualization 452, the feasibility parameters 294 are replaced with one or more vulnerable assets that make the attack paths 155 feasible. In the case of the visualization 452, the asset 123DA and the asset 123CA provide a first feasible attack path 155 from the asset 123DB to the PII 440 and the PCI 444. Further, the asset 123DA provides a second feasible attack path 155 from the asset 123DB to the PCI 444. In addition, the size of the PII 440 and the size of the PCI 444 are modified in accordance with one or more corresponding weighted costs 194 (e.g., based on the volume of sensitive assets exposed or the priority of the category of assets at risk). In this regard, the PII 440 is smaller than the PCI 444, which may indicate that a volume of the PCI 444 data is more greater than a volume of the PII 440 data exposed or may indicate that the PII 440 is more relevant to the application layers 122 than the PII 440. To this end, the attack path determination engine 270 may prioritize remediation of the vulnerabilities in the attack path that enables attack vectors 192 to reach the PCI 444.

The process 400 ends at operation 430, where the one or more processors 120 provide results to the storage and databases 150. As shown in visualization 454, the results may comprise selecting an attack path 155 to reach the PCI 444 as the attack path 155 to remediate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein.

Modifications, additions, or omissions may be made to the elements shown in the figures above. The components of a device may be integrated or separated. Moreover, the functionality of a device may be performed by more, fewer, or other components. The components within a device may be communicatively coupled in any suitable manner. Functionality described herein may be performed by one device or distributed across multiple devices. In general, systems and/or components described in this disclosure as performing certain functionality may comprise non-transitory computer readable memory storing instructions and processing circuitry operable to execute the instructions to cause the system/component to perform the described functionality.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry configured to execute program code stored in memory. The term unit may have conventional meaning in the field of electronics, electrical devices and/or electronic devices and may include, for example, electrical and/or electronic circuitry, devices, modules, processors, receivers, transmitters, memories, logic solid state and/or discrete devices, computer programs or instructions for carrying out respective tasks, procedures, computations, outputs, and/or displaying functions, and so on, as such as those that are described herein.

1. A system, comprising:
a memory configured to store:
asset inventory indicating a plurality of application assets;
a first plurality of attack vector parameters configured to indicate vulnerabilities of one or more of the plurality of application assets; and
asset mapping information configured to associate each of the plurality of application assets to one or more of a plurality of application layers, the plurality of application layers comprising an application data layer, an application logic layer, an application infrastructure layer, and an application cloud infrastructure layer; and
a processor communicatively coupled to the memory and configured to:
determine a first plurality of vulnerable assets in the plurality of application assets based at least in part upon the first plurality of attack vector parameters;
determine a first plurality of feasibility parameters that indicate a first likelihood of a first attack path to occur in the system;
generate a visual interface showing the first plurality of vulnerable assets;
determine the first attack path connecting the first plurality of vulnerable assets based at least in part upon the asset mapping information; and
map the first attack path to the plurality of application layers in the visual interface based at least in part upon the first plurality of feasibility parameters.

2. The system of claim 1, wherein:
the first plurality of feasibility parameters further indicate a first starting point of the first attack path.

3. The system of claim 2, wherein the processor is further configured to:
obtain a second plurality of attack vector parameters;
determine a second plurality of vulnerable assets in the plurality of application assets based at least in part upon the second plurality of attack vector parameters;
generate the visual interface showing the first plurality of vulnerable assets and the second plurality of vulnerable assets;
determine a second attack path connecting the second plurality of vulnerable assets based at least in part upon the asset mapping information;
determine a second plurality of feasibility parameters that indicate a second likelihood of the second attack path to occur in the system, the second plurality of feasibility parameters further indicate a second starting point of the second attack path; and
map the second attack path to the plurality of application layers in the visual interface based at least in part upon the second plurality of feasibility parameters.

4. The system of claim 3, wherein the processor is further configured to:
in conjunction with determining the first plurality of vulnerable assets, determine a first weighted cost to compromise the first plurality of vulnerable assets from the first attack path;
in conjunction with determining the second plurality of vulnerable assets, determine a second weighted cost to compromise the second plurality of vulnerable assets from the second attack path;
determine whether the first weighted cost is greater than the second weighted cost;
in response to determining that the first weighted cost is greater than the second weighted cost, prioritize remediation for the second attack path; and
in response to determining that the second weighted cost is greater than the first weighted cost, prioritize remediation for the first attack path.

5. The system of claim 4, wherein the processor is further configured to:
in response to the second weighted cost being greater than the first weighted cost, generate a first plurality of threat prioritization parameters that indicate first corresponding priorities for each vulnerable asset in the first plurality of vulnerable assets;
generate a first plurality of remediation parameters that indicate a first solution to remediate the first attack path in the system;
assign the first plurality of threat prioritization parameters and the first plurality of remediation parameters to the first attack path in the visual interface;
in response to the first weighted cost being greater than the second weighted cost, generate a second plurality of threat prioritization parameters that indicate second corresponding priorities for each vulnerable asset in the second plurality of vulnerable assets;
generate a second plurality of remediation parameters that indicate a second solution to remediate the second attack path in the system; and
assign the second plurality of threat prioritization parameters and the second plurality of remediation parameters to the second attack path in the visual interface.

6. The system of claim 1, wherein:
the first plurality of attack vector parameters comprise a comprehensive list of attack vectors.

7. The system of claim 1, wherein:
the first plurality of attack vector parameters comprise information indicating the vulnerabilities and potential intrusions in the plurality of application layers.

8. A method, comprising:
obtaining a plurality of parameters, comprising:
asset inventory indicating a plurality of application assets;
a first plurality of attack vector parameters configured to indicate vulnerabilities of one or more of the plurality of application assets; and
asset mapping information configured to associate each of the plurality of application assets to one or more of a plurality of application layers, the plurality of application layers comprising an application data layer, an application logic layer, an application infrastructure layer, and an application cloud infrastructure layer;
determining a first plurality of vulnerable assets in the plurality of application assets based at least in part upon the first plurality of attack vector parameters;
determining a first plurality of feasibility parameters that indicate a first likelihood of a first attack path to occur in a system;
generating a visual interface showing the first plurality of vulnerable assets;
determining the first attack path connecting the first plurality of vulnerable assets based at least in part upon the asset mapping information; and
mapping the first attack path to the plurality of application layers in the visual interface based at least in part upon the first plurality of feasibility parameters.

9. The method of claim 8, wherein:
the first plurality of feasibility parameters further indicate a first starting point of the first attack path.

10. The method of claim 9, further comprising:
obtaining a second plurality of attack vector parameters;
determining a second plurality of vulnerable assets in the plurality of application assets based at least in part upon the second plurality of attack vector parameters;
generating the visual interface showing the first plurality of vulnerable assets and the second plurality of vulnerable assets;
determining a second attack path connecting the second plurality of vulnerable assets based at least in part upon the asset mapping information;
determining a second plurality of feasibility parameters that indicate a second likelihood of the second attack path to occur in the system, the second plurality of feasibility parameters further indicate a second starting point of the second attack path; and
mapping the second attack path to the plurality of application layers in the visual interface based at least in part upon the second plurality of feasibility parameters.

11. The method of claim 10, further comprising:
in conjunction with determining the first plurality of vulnerable assets, determining a first weighted cost to compromise the first plurality of vulnerable assets from the first attack path;
in conjunction with determining the second plurality of vulnerable assets, determining a second weighted cost to compromise the second plurality of vulnerable assets from the second attack path;
determining whether the first weighted cost is greater than the second weighted cost;
in response to determining that the first weighted cost is greater than the second weighted cost, prioritizing remediation for the second attack path; and
in response to determining that the second weighted cost is greater than the first weighted cost, prioritizing remediation for the first attack path.

12. The method of claim 11, further comprising:
in response to the second weighted cost being greater than first weighted cost, generating a first plurality of threat prioritization parameters that indicate first corresponding priorities for each vulnerable asset in the first plurality of vulnerable assets;
generating a first plurality of remediation parameters that indicate a first solution to remediate the first attack path in the system;
in response to the first weighted cost being greater than the second weighted cost, generating a second plurality of threat prioritization parameters that indicate second corresponding priorities for each vulnerable asset in the second plurality of vulnerable assets;
generating a second plurality of remediation parameters that indicate a second solution to remediate the second attack path in the system; and
assigning the second plurality of threat prioritization parameters and the second plurality of remediation parameters to the second attack path in the visual interface.

13. The method of claim 8, wherein:
the first plurality of attack vector parameters comprise a comprehensive list of attack vectors.

14. The method of claim 8, wherein:
the first plurality of attack vector parameters comprise information indicating the vulnerabilities and potential intrusions in the plurality of application layers.

15. A non-transitory computer readable medium storing instructions that when executed by a processor cause the processor to:
obtain a plurality of parameters, comprising:
asset inventory indicating a plurality of application assets;
a first plurality of attack vector parameters configured to indicate vulnerabilities of one or more of the plurality of application assets; and
asset mapping information configured to associate each of the plurality of application assets to one or more of a plurality of application layers, the plurality of application layers comprising an application data layer, an application logic layer, an application infrastructure layer, and an application cloud infrastructure layer;
determine a first plurality of vulnerable assets in the plurality of application assets based at least in part upon the first plurality of attack vector parameters;
determine a first plurality of feasibility parameters that indicate a first likelihood of a first attack path to occur in a system;
generate a visual interface showing the first plurality of vulnerable assets;
determine the first attack path connecting the first plurality of vulnerable assets based at least in part upon the asset mapping information; and
map the first attack path to the plurality of application layers in the visual interface based at least in part upon the first plurality of feasibility parameters.

16. The non-transitory computer readable medium of claim 15, wherein:
the first plurality of feasibility parameters further indicate a first starting point of the first attack path.

17. The non-transitory computer readable medium of claim 16, wherein the instructions further cause the processor to:
obtain a second plurality of attack vector parameters;
determine a second plurality of vulnerable assets in the plurality of application assets based at least in part upon the second plurality of attack vector parameters;
generate the visual interface showing the first plurality of vulnerable assets and the second plurality of vulnerable assets;
determine a second attack path connecting the second plurality of vulnerable assets based at least in part upon the asset mapping information;
determine a second plurality of feasibility parameters that indicate a second likelihood of the second attack path to occur in the system, the second plurality of feasibility parameters further indicate a second starting point of the second attack path; and
map the second attack path to the plurality of application layers in the visual interface based at least in part upon the second plurality of feasibility parameters.

18. The non-transitory computer readable medium of claim 17, wherein the instructions further cause the processor to:
in conjunction with determining the first plurality of vulnerable assets, determine a first weighted cost to compromise the first plurality of vulnerable assets from the first attack path;
in conjunction with determining the second plurality of vulnerable assets, determine a second weighted cost to compromise the second plurality of vulnerable assets from the second attack path;
determine whether the first weighted cost is greater than the second weighted cost;
in response to determining that the first weighted cost is greater than the second weighted cost, prioritize remediation for the second attack path; and
in response to determining that the second weighted cost is greater than the first weighted cost, prioritize remediation for the first attack path.

19. The non-transitory computer readable medium of claim 18, wherein the instructions further cause the processor to:
in response to the second weighted cost being greater than the first weighted cost, generate a first plurality of threat prioritization parameters that indicate first corresponding priorities for each vulnerable asset in the first plurality of vulnerable assets;
generate a first plurality of remediation parameters that indicate a first solution to remediate the first attack path in the system;
in response to the first weighted cost being greater than the second weighted cost, generate a second plurality of threat prioritization parameters that indicate second corresponding priorities for each vulnerable asset in the second plurality of vulnerable assets;
generate a second plurality of remediation parameters that indicate a second solution to remediate the second attack path in the system; and
assign the second plurality of threat prioritization parameters and the second plurality of remediation parameters to the second attack path in the visual interface.

20. The non-transitory computer readable medium of claim 15, wherein:
the first plurality of attack vector parameters comprise information indicating the vulnerabilities and potential intrusions in the plurality of application layers.
